(19) United States
(12) Patent Application Publication
(10) Pub. No.: US 2006/0171269 A1
(43) Pub. Date: Aug. 3, 2006

(54) Information recording and reproducing apparatus and method of reproducing BCA signal at high accuracy

(75) Inventors: Takehiro Hiramatsu, Yokohama-shi (JP); Sumitaka Maruyama, Yokohama-shi (JP); Yukiyasu Tatsuzawa, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/339,535

(22) Filed: Jan. 26, 2006

(30) Foreign Application Priority Data
Jan. 31, 2005 (JP) 2005-024480

(51) Int. Cl. G11B 5/09

(52) U.S. Cl. 369/47.1; 369/59.1

(57) ABSTRACT

One embodiment of the invention, a BCA signal is reproduced properly from a BCA while inhibiting influences properly from a groove contained in a reproduction signal, when a signal is reproduced from an additional writing type optical disk provided with the groove by cutting the DC component of an envelop detected from the BCA signal by an AC coupling section and then comparing with a predetermined threshold with a comparator.

### CROSS-REFERENCE TO RELATED APPLICATIONS

This application is based upon and claims the benefit of priority from prior Japanese Patent Application No. 2005-024480, filed Jan. 31, 2005, the entire contents of which are incorporated herein by reference.

### BACKGROUND

1. Field

One embodiment of the invention relates to an optical disk recording and reproducing apparatus (information recording and reproducing apparatus) and a signal reading method for recording information into an optical disk which enables information to recorded, deleted or reproduced by using a laser beam.

2. Description of the Related Art

An optical disk has been widely used as a recording medium suitable for recording, reproducing and deleting (repetitive recording) information. On the contrary, optical disks of various standards have been proposed and actually used. In the meantime, those optical disks of various standards are classified to CD standard or DVD standard if they are classified according to recording capacity. Further, from viewpoints of application (data recording type), the optical disks are classified to reproduction specialized type in which information is already recorded (called ROM), write-once type (additional writing type) which allows information to be written only once (called −R), rewritable type which allows repeated recording and deletion (called RAM or RW) (recording and reproducing type or rewritable type) and the like.

With diversification of the standard and application of the optical disk, the optical disk main body is provided with an area, called a burst cutting area (BCA), in which information for a disk drive to identify each disk and copy protection information inherent of each disk are recorded.

It is disclosed by, for example, Japanese Patent Application Publication (KOKAI) No. 2001-243636 has disclosed a method of recording BCA in a recording type (that is, additional writing type or rewritable type) optical disk stably and forming a BCA pattern therein.

The publication states binarization using a level slicer when reproducing a BCA signal from an optical disk in which the BCA is recorded.

However, there is such a problem that the BCA signal is not reproduced properly because, when the BCA signal is reproduced in a recording type optical disk having the groove (guide groove, i.e., track), a track cross signal due to a groove rides on the BCA signal (reproduced simultaneously with the BCA signal).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A is an exemplary diagram showing an example of an optical disk having a groove in BCA to which an embodiment of the present invention can be adapted;

FIG. 1B is an exemplary schematic view for explaining the BCA shown in FIG. 1A in enlargement;

FIG. 2 is an exemplary diagram showing an example of an optical disk drive unit (information recording and reproducing apparatus) for reproducing information from the optical disk shown in FIG. 1A;

FIGS. 3A and 3B are exemplary schematic views each for explaining the relation between a signal reproduced from the optical disk shown in FIG. 1A by using the optical disk drive unit shown in FIG. 2, and the groove;

FIG. 4 is a flow chart an exemplary showing an example of a method of reducing an influence of a track cross signal from the BCA signal by means of the optical disk drive unit shown in FIG. 2;

FIG. 5 is an exemplary diagram for explaining an example of a configuration for detecting an envelope from the BCA signal by means of the optical disk drive unit shown in FIG. 2;

FIG. 6 is an exemplary diagram for explaining an example of a configuration for determining whether or not there is any groove according to a signal having envelope detected from the BCA signal by means of the optical disk drive unit shown in FIG. 2;

FIG. 7 is a flow chart an exemplary showing another example of a method of reducing an influence of the track cross signal from the BCA signal by means of the optical disk drive unit shown in FIG. 2;

FIG. 8 is an exemplary schematic view for explaining an example of a band pass filter for use in the optical disk drive unit shown in FIG. 2;

FIG. 9 is a flow chart an exemplary showing a further example of a method of reducing an influence of the track cross signal from the BCA signal by means of the optical disk drive unit shown in FIG. 2;

FIG. 10 is an exemplary schematic view for explaining an example of a slicing circuit for use in the optical disk drive unit shown in FIG. 2; and

FIGS. 11A and 11B are exemplary schematic views each for explaining the relation between a track pitch of the groove in the BCA of the optical disk shown in FIG. 1A and the BCA signal.

### DETAILED DESCRIPTION

Various embodiments according to the invention will be described hereinafter with reference to the accompanying drawings. In general, according to one embodiment of the invention, a BCA signal is reproduced properly from a BCA while inhibiting influences of components of a groove contained in a reproduction signal, when a signal is reproduced from an additional writing type optical disk provided with the groove by cutting the DC component of an envelop detected from the BCA signal by an AC coupling section and then comparing with a predetermined threshold with a comparator.

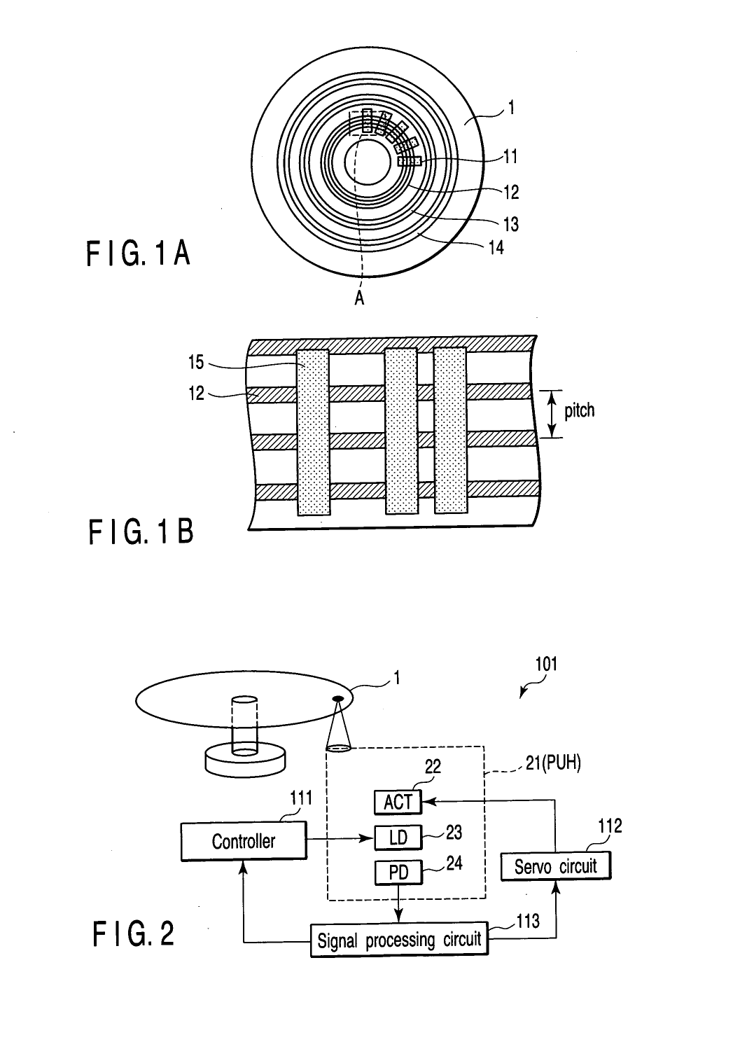

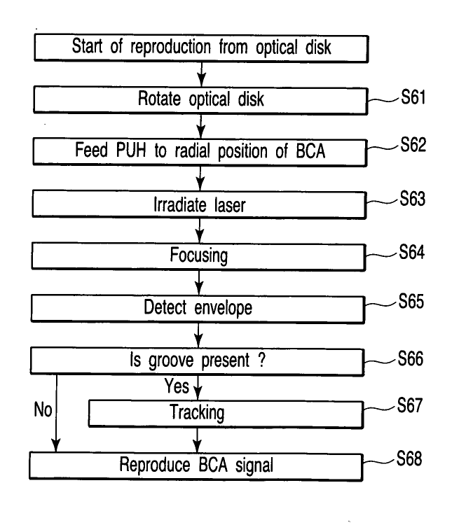

According to an embodiment, as shown in FIG. 1A, the optical disk 1 includes a burst cutting area (BCA) 11 and a groove 12, a system lead-in area 13, and a data area 14. In the BCA 11 and groove 12, information for use for identification of the type of an optical disk by an optical disk drive unit (recording and reproducing apparatus), which will be described later with reference to FIG. 2, and copy protection information inherent in various kinds of optical disks are recorded. The system lead-in area 13 is located outside the BCA 11 and the groove 12, and the data area 14 is specified further outside the system lead-in area 13. The optical disk 1 is an additional writing type optical disk using an organic pigment material having a diameter of about 120 mm and a thickness of about 1.2 mm as its recording layer. However, the embodiment of the present invention is not restricted to this example.

A track pitch of the system lead-in area 13 is, for example, 0.68 μm, and a track pitch of the data area 14 is, for example, 0.40 μm. The wavelength of optical beam (laser beam) to be used for recording information into the data area 14 of the optical disk 1 and reproducing information is, for example, 405 nm.

FIG. 1B shows a BCA signal 15 of the BCA 11 shown in FIG. 1A in enlargement in detail, which is recorded as if it traverses the groove 12 formed concentrically.

FIG. 2 shows an example of the optical disk drive unit (information recording and reproducing apparatus) for recording information into the optical disk shown in FIGS. 1A and 1B or reproducing information from the optical disk.

The optical disk drive unit 101 includes an optical pickup head (PUH) 21 which irradiates a light beam (laser beam) having a predetermined wavelength to a recording face of the optical disk 1 or receives a laser beam reflected by the recording face of the optical disk 1 so as to output an electric signal corresponding to the intensity of the beam.

The PUH 21 has an actuator (ACT) 22, a light source (LD) 23, a photo detector (PD) 24, and the like. The actuator (ACT) 22 supports an objective lens (not shown) provided at a predetermined position in a direction perpendicular to the recording face (information recording layer) of the optical disk 1 and in a direction perpendicular to the grooves (guide grooves, namely, tracks) 12, 13 formed preliminarily in an information recording layer while parallel to the information recording layer of the optical disk 1. The laser diode 23 is, for example, a semiconductor laser device. The photo detector 24 receives laser beam reflected by the information recording layer of the optical disk 1, the laser beam being outputted from the laser diode 23 so as to output an electric signal of a magnitude corresponding to the intensity of the light.

Recording of information into the optical disk 1 and reproduction of information from the optical disk 1 are enabled by focusing a laser beam emitted from the pickup head (PUH) 21 on the information recording layer of the optical disk 1.

Reflection light (reflected laser beam) from the optical disk 1 is detected by the photo diode (PD) 24 of the PUH 21 and converted to an electric signal of a magnitude corresponding to the intensity of the light, and then inputted to a signal processing circuit 113.

An output of the signal processing circuit 113 is used to obtain a servo signal for use in controlling the position of the actuator (ACT) 22 by means of, for example, a servo circuit 112. Further, the output of the signal processing circuit 113 is used to control the intensity of the laser beam outputted from the laser diode 23 by means of, for example, a controller 111.

The optical disk 1 is supported by a disk motor (not shown) and rotated at a predetermined speed by the disk motor which rotates at a predetermined speed.

The PUH 21 moves at a predetermined speed in the diameter direction of the optical disk 1 in each of operations for recording, reproduction or deleting information by a pickup feeding motor (not shown).

As the optical disk 1 which enables the optical pickup (PUH) 21 of the present invention to read reflected optical beam for controlling at least tracking (position in a direction perpendicular to the grooves (guide grooves, namely, tracks) 12 and 13 formed preliminarily in the information recording layer), a next-generation DVD (hereinafter referred to as HD DVD) standard optical disk is available, the DVD standard optical disk being capable of recording at higher density than, for example, a new DVD standard optical disk. Needless to say, a variety of well known disks such as a current DVD standard based DVD-RAM disk allowing recording and deleting of information, a DVD-RW disk, a DVD-R disk allowing writing of new information, a DVD-ROM disk in which information is already recorded are available.

FIGS. 3A and 3B show schematic views of a reproduction waveform of the BCA signal of the optical disk of the invention.

As shown in FIG. 3A, the waveform of the reproduction signal is substantially uniform in a disk having no groove (12) in the BCA 11 (see FIGS. 1A and 1B).

However, in the optical disk 1 in which the groove 12 is formed in the BCA 11 as shown in FIG. 3B, the BCA signal is not reproduced properly because a track cross signal rides on the BCA signal (the track cross signal is reproduced at the same time as the BCA signal).

The feature of the present invention is that the BCA signal is reproduced properly by making the PUH 21 track when the BCA signal is reproduced from the BCA 13 in order to suppress generation of a track cross signal.

FIG. 4 shows a flow chart for reproducing the BCA signal of the invention.

If reproduction of information recorded in the optical disk 1 is instructed, the optical disk 1 is rotated at a revolution speed specified preliminarily for reproduction of the BCA signal (S61).

Next, the PUH 21 is fed to the radial position of the optical disk in which the BCA is recorded, the position being determined preliminarily (S62).

Subsequently, a laser beam having an inherent reproduction power preliminarily determined is outputted from the laser source (LD) 23 (see FIG. 2) and irradiated to the BCA 11 (S63).

Next, focusing of the objective lens (not shown) of the ATC 22 is controlled so as to irradiate the laser beam of reproduction power to the BCA in an on-focus state (S64).

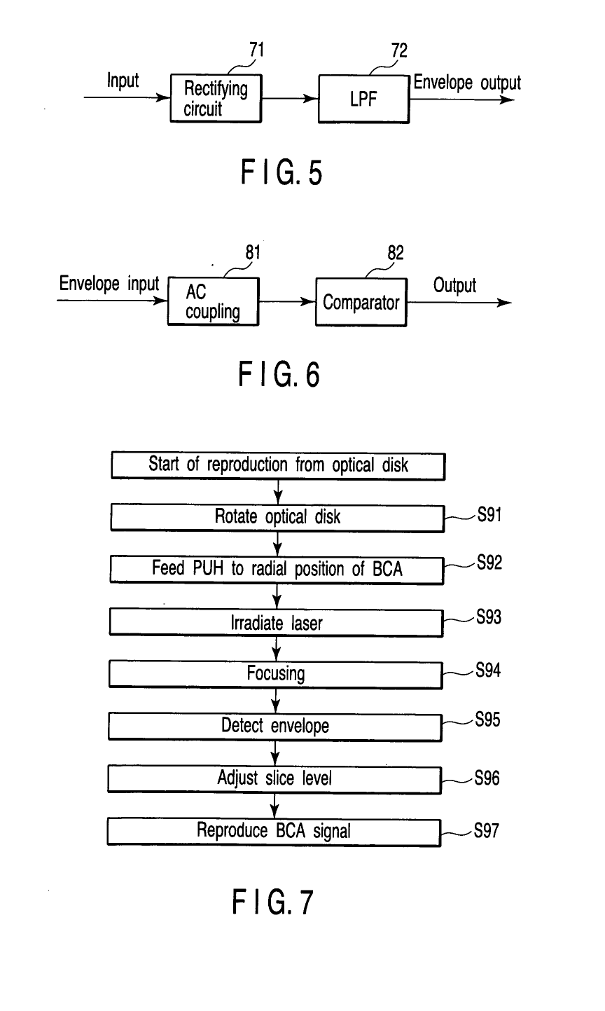

Subsequently, a signal envelope is detected from the reproduction signal from the BCA 11 (S65). In detail the envelope is detected by filtering the BCA signal (input) with a low pass filter (LPF) 72 after rectify in a rectifying circuit 71 as shown in FIG. 5. In the meantime, the rectifying circuit 71 and the LPF 72 may be firmware of the controller 111 shown in FIG. 2.

Hereinafter, whether or not any groove presents in the groove of the BCA of the optical disk 1 is determined from the detected envelope (S66). Whether or not any groove 12 exists in the BCA of the optical disk 1 is determined by cutting a DC component of the envelope with an AC coupling section 81 and comparing with a predetermined threshold with a comparator 82 as shown in FIG. 6. In the meantime, the AC coupling section 81 and the comparator 82 may be firmware of the controller 111 shown in FIG. 2.

If it is determined that the groove 12 exists in the BCA in step S66, the PUH 21 (objective lens (not shown) thereof) is made to track (S67).

It becomes possible to remove the track cross signal from the BCA signal by making the PUH 21 track in step S67, so that a proper BCA signal can be obtained by binarizing the reproduction signal from the BCA following a predetermined slice level (S68).

If it is determined that no groove 12 presents in the BCA in step S66, needles to say, the BCA signal is reproduced in step S68.

FIG. 7 shows an example of a method of removing the track cross signal from the BCA signal.

For example, the BCA signal can be fetched out by modulating the slice level of the BCA signal according to a track cross signal if the track cross signal rides on the BCA signal (the track cross signal is reproduced at the same time as the BCA signal).

If reproduction of information recorded in the optical disk 1 is instructed, the optical disk 1 is rotated at a predetermined revolution speed for reproduction of the BCA signal (S91).

Next, the PUH 21 is fed to a predetermined radial position of the optical disk in which the BCA is recorded (S92).

Subsequently, a laser beam of inherent reproduction power preliminarily determined is outputted from the laser (LD) 23 and irradiated on the BCA 11 (S93).

Next, focusing of the objective lens (not shown) of the ACT 22 is controlled, and the laser beam of reproduction power is irradiated to the BCA in the on-focus state (S94).

Subsequently, the signal envelope is detected from the reproduction signal from the BCA 11 (S95). In detail the envelope is detected by filtering the BCA signal (input) with a low pass filter (LPF) 72 after rectify in a rectifying circuit 71 as shown in FIG. 5.

Hereinafter, the detected envelope is sliced by a slicing circuit (not shown) with the amplitude of about half the envelope as a slice level as shown in FIG. 10 (S96).

Then, the signal in the BCA is binarized according to a slice level obtained by slicing in step S96 (S97). Because the slice level changes following the track cross signal by setting the slice level to an amplitude of about half the envelope as shown in FIG. 10, an influence of the track cross upon binarization can be eliminated.

When there is no groove, the slice level is uniform, so that the BCA signal can be reproduced properly regardless of presence/absence of the groove.

FIG. 9 shows an example of another method of removing the track cross signal from the BCA signal.

For example, if the track cross signal is riding on the BCA signal (the track cross signal is reproduced at the same time as the BCA signal), the BCA signal can be picked out by passing the BCA signal through a band pass filter. Steps S101 to S104 described below are substantially equal to steps S61 to S64 shown in FIG. 4 or steps S91 to S94 shown in FIG. 9, thus a detailed description thereof is omitted.

If focusing of the objective lens (not shown) is controlled so that laser beam of reproduction power is irradiated to the BCA in on focus condition in step S104, the reproduction signal from the BCA is obtained.

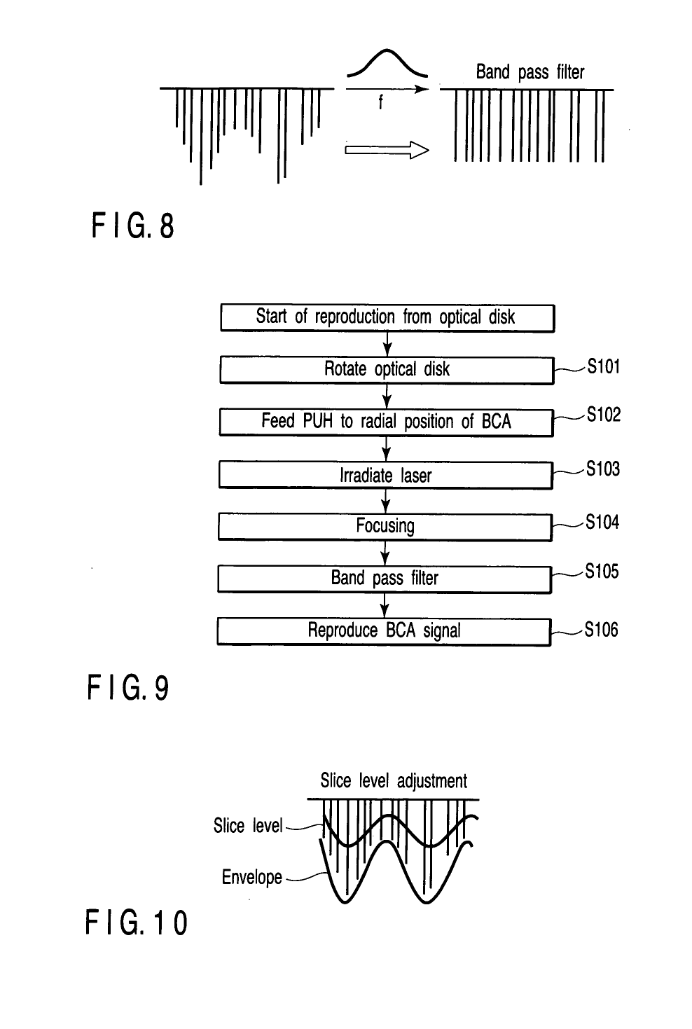

Here, a band pass filter having the characteristic shown in FIG. 8 is applied to the reproduction signal from the BCA (the BCA reproduction signal is passed through the band pass filter). The band pass filter has a lower cut-off frequency and a higher cut-off frequency. A lower limit of the lower cut-off frequency is set a value as a result of dividing double the eccentricity of the disk by a track pitch on the disk. A higher limit of the lower cut-off frequency is lower than 50 kHz. The cut-off frequency on the higher cut-off frequency is set to 550 kHz (obtained by dividing the basic frequency of a sequence in a BCA signal whose pitch is the shortest by 2) (S105).

A proper BCA signal can be obtained by binarizing the BCA signal passing through the band pass filter by a predetermined slice level (S106). Needless to say, only the track cross signal is cut by the band pass filter because the BCA signal contains a predetermined frequency component.

Thus, the BCA signal can be reproduced regardless of whether or not any groove exists because there is no influence even if the band pass filter is applied to the BCA signal.

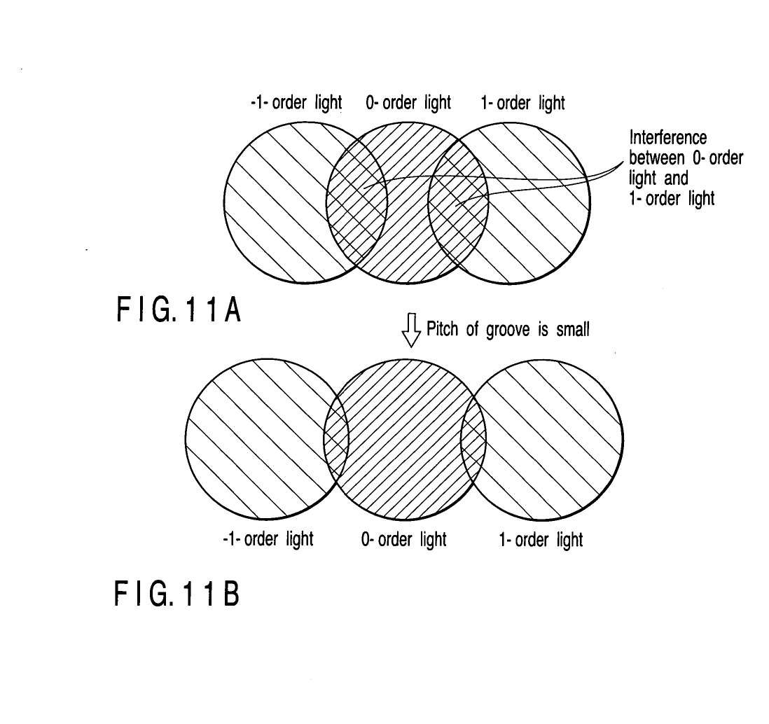

If the track pitch of the groove in the BCA is narrower than the pitch of the groove in the system lead-in area, a distance of light spots by “±1-order diffracted light” and “0-order light” extends as shown in FIGS. 11A and 11B.

In this case, the influence of interference decreases because the area of a region in which the “0-order light” and “±1-order diffracted light” overlap each other decreases. Thus, the track cross signal decreases and the BCA signal being reproduced more properly.

On the contrary, if the track pitch of the groove in the BCA is wider than the system lead-in area, this is advantageous for reducing the influence of the track cross signal using the band pass filter, because the frequency band of the track cross signal lowers.

Thus, the pitch of the groove in the BCA is preferred to be different from the track pitch of the system lead-in area.

For example, the pitch of the groove is preferred to be 0.5 to 0.95 times or 1.05 to 2 times the track pitch of the system lead-in area.

Needless to say, respective methods of making the PUH track, changing the slice level and applying the band pass filter to reduce an influence of the track cross when reproducing the BCA signal from the BCA may be executed independently or in any combination.

As described above, according to the present invention, when the BCA signal is reproduced in regard to an optical disk capable of recording information about a groove (guide groove, namely, track), the signal components of the track (groove) can be removed easily from the BCA signal even if a track cross signal caused by the groove is reproduced at the same time as the BCA signal such that it is overlaid on the BCA signal. Therefore, the BCA signal can be reproduced properly without being influenced by signal components of the groove contained in a reproduction signal from the BCA.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording and reproducing apparatus comprising:
an optical pickup comprising an objective lens and a photo detector which receives reflection light reflected by an information storage region of an information storage medium after the light is focused on the information storage region through the objective lens, the optical pickup outputting an output signal corresponding to the reflection light from the information storage medium; and
a signal processing circuit which removes from the output signal an output component different from information typical of the information storage medium of the output signal from a specified area prepared on an inner circumference of the information storage region of the information storage medium, at least the information typical of the information storage medium being recorded in the specified area.

2. The information recording and reproducing apparatus according to claim 1, wherein the specified area of the information storage region of the information storage medium is provided with a characteristic of a physical shape typical of the information storage medium.

3. The information recording and reproducing apparatus according to claim 2, wherein the signal processing circuit removes an output component different from the typical information from the output signal emitted from the photo detector, with the objective lens located substantially in the center of the characteristic of the physical shape, by outputting a signal for controlling the position of the optical pickup such that a focusing spot of the light focused by the objective lens of the optical pickup is located substantially in the center of the feature of the physical shape of the information storage medium.

4. The information recording and reproducing apparatus according to claim 1, wherein the signal processing circuit detects an envelope of the output signal emitted from the photo detector to change a threshold level for binarizing the output signal on the basis of the degree of a change when the envelope changes.

5. The information recording and reproducing apparatus according to claim 4, wherein the threshold level is set in accordance with changes in the amplitude of the envelope.

6. The information recording and reproducing apparatus according to claim 1, wherein the signal processing circuit extracts only a predetermined band component in regard to an output from the specified area of the output signal of the photo detector.

7. The information recording and reproducing apparatus according to claim 6, wherein the predetermined band component is specified by a value as a result of dividing double the eccentricity of the information recording medium by a pitch repeating the characteristic of the physical shape and a value as a result of dividing a frequency of a sequence in the BCA signal whose pitch is the shortest by 2.

8. An information recording and reproducing apparatus configured to reproduce a BCA signal of an information storage medium in which a groove pattern has been formed in a predetermined area near the inner circumference, comprising:
an optical pickup comprising an objective lens and a photo detector which receive reflection light reflected by an information storage region of an information storage medium after the light is focused on the information storage region through the objective lens, the optical pickup outputting an output signal corresponding to the reflection light from the information storage medium; and
a signal processing circuit which, when a track is preliminarily formed in a system lead-in area typical of the information storage medium, extracts from the output signal a BCA signal component of the output signal from a specified area having recorded therein information typical of the information storage medium recorded in the information storage region together with the groove pattern of the information storage medium.

9. A method of reproducing a BCA signal of an information storage medium in which a groove pattern has been formed in a specified area near the inner circumference at a high accuracy, the method comprising:
detecting reflection light reflected by an information storage region of the information storage medium;
generating an output signal which is an output corresponding to the intensity of the detected reflection light; and
to obtain the BCA signal by removing an influence of the groove from the output signal, executing at least any one of processes of,
detecting the output signal with an objective lens of an optical pickup located substantially in the center of the groove such that a focus spot of light focused by the objective lens is located substantially in the center of the groove in the information storage medium;
changing a threshold level for binarizing the output signal on the basis of the degree of a change of an envelope; and
picking out only the BCA signal with a value as a result of dividing double the eccentricity of the information storage medium by a pitch of the groove and a value as a result of dividing a frequency of a sequence in the BCA signal whose pitch is the shortest by 2.
